(19) United States
(12) Patent Application Publication
(10) Pub. No.: US 2005/0251806 A1
(43) Pub. Date: Nov. 10, 2005

(54) Enhancement of real-time operating system functionality using a hypervisor

(76) Inventors: Marc A. Auslander, Millwood, NY (US); Boas Betzler, Magstadt (DE); Dilma M. Da Silva, White Plains, NY (US); Michael N. Day, Round Rock, TX (US); Orran Y. Krieger, Newton, MA (US); Paul E. McKenney, Beaverton, OR (US); Michal Ostrowski, New York, NY (US); Bryan S. Rosenburg, Cortlandt Manor, NY (US); Robert W. Wisniewski, Yorktown Heights, NY (US); James Xenidis, Carmel, NY (US)

Correspondence Address: WALTER W. DUFT;LAW OFFICES OF WALTER W. DUFT, 8616 MAIN ST, SUITE 2, WILLIAMSVILLE, NY, 14221, US

(21) Appl. No.: 10/842,281

(22) Filed: May 10, 2004

(51) Int. Cl. G06F 9/46

(52) U.S. Cl. 718/100

(57) ABSTRACT

A system, method and computer program product for enhancing a real-time operating system (RTOS) with functionality normally associated with a general purpose operating system (GPOS). A hypervisor that is adapted to perform a real-time scheduling function supports concurrent execution of an RTOS and a GPOS on a system of shared hardware resources. The RTOS or its applications can utilize services provided by the GPOS. Such services may include one or more of file system organization, network communication, network management, database management, security, user-interface support and others. To enhance operational robustness and security, the hypervisor can be placed in read-only storage while maintaining the ability to update scheduling mechanisms. A programmable policy manager that is maintained in read-write storage can be used to dictate scheduling policy changes to the hypervisor as required to accommodate current needs.

### BACKGROUND OF THE INVENTION

1. Field of the Invention

This invention relates to real-time operating systems. More particularly, the invention is directed to the enhancement of real-time operating system functionality to provide all of the capabilities normally found in general purpose operating systems.

2. Description of the Prior Art

By way of background, many applications having hard real-time requirements, such as embedded systems controlling critical processes, are demanding increasing functionality in such areas as file system organization, network communication, network management, database management, security, user-interface support, etc. Unfortunately, it is typically difficult and expensive to keep a proprietary real-time operating system (RTOS) up to date with respect to this increasing level of function. General purpose operating systems (GPOSes) tend to keep pace with the latest functional enhancements, but such operating systems do not support hard real-time requirements. It is also expensive to train programmers on multiple environments, especially environments that have little unit volume. This situation provides motivation for some way of making use of stock applications from popular GPOSes in an RTOS-controlled system.

Previous proposals for satisfying real-time requirements while providing GPOS-like functionality include (1) adding real-time extensions to an existing GPOS, (2) running an existing GPOS in a user-process context under an existing RTOS, and (3) building a GPOS personality on top of an existing RTOS. There are various drawbacks associated with each of these proposals.

Adding real-time extensions to an existing GPOS allows support of “soft” real-time requirements, but not “hard” real-time requirements. In this context, the term “hard real-time” signifies a system whose timing behavior is wholly deterministic, such that response to an event can be guaranteed to occur within some fixed time. In contrast, the term “soft real-time” refers to a system that will do its best to service an event within a specified time, and will do so on average, but cannot guarantee this result.

Running an existing GPOS in a user-process context of an RTOS requires the RTOS to incorporate device level support for the desired functionality, such as networking and mass-storage support. In addition, the RTOS can suffer a performance penalty for masking and unmasking interrupts, passing interrupts to the GPOS, manipulating memory traps, and handling I/O. A GPOS running in user context also cannot be protected from the underlying RTOS's misbehavior or bugs. Any kernel panic in the RTOS will bring down the GPOS as well.

Building a GPOS personality on top of an existing RTOS incurs non-trivial development expense to keep up with changes in the GPOS. In addition, it is almost never feasible to make a personality 100% compatible with a native GPOS implementation. Any differences that exist may require that changes be made to applications that run on the OS, with consequent increase in development and maintenance costs.

Accordingly, it would be desirable to provide a solution by which functionality normally associated with a GPOS could be provided on behalf of an RTOS, without the disadvantages associated with the above-described proposals.

### SUMMARY OF THE INVENTION

The foregoing problems are solved and an advance in the art is obtained by a novel system, method and computer program product for enhancing a real-time operating system (RTOS) with functionality normally associated with a general-purpose operating system (GPOS). To that end, a hypervisor that performs a real-time scheduling function is used to support concurrent execution of an RTOS and a GPOS on a system of shared hardware resources. The RTOS or its applications can thus utilize services provided by the GPOS. Such services may include one or more of file system organization, network communication, network management, database management, security, user-interface support and others. To enhance operational robustness and security, the hypervisor can be placed in read-only storage while still maintaining the ability to update scheduling mechanisms. A programmable policy manager that is maintained in read-write storage can be used to selectively dictate scheduling policy changes to the hypervisor as required to accommodate current needs.

### BRIEF DESCRIPTION OF THE DRAWINGS

The foregoing and other features and advantages of the invention will be apparent from the following more particular description of preferred embodiments of the invention, as illustrated in the accompanying Drawings, in which:

FIG. 1 is a functional block diagram showing a system of shared data processing hardware resources, with the system running a hypervisor, three RTOSes and a GPOS within dedicated virtual machine environments;

FIG. 2 is a functional block diagram showing a system of shared data processing hardware resources, with the system running a hypervisor and two RTOSes and a GPOS within dedicated virtual machine environments, together with a programmable policy manager for updating the hypervisor's scheduling algorithms;

FIG. 3 is a timeline showing the division of a real-time video frame interval into plural hypervisor time slot scheduling intervals;

FIG. 4 is a functional block diagram showing prioritized process-context run queues assigned to four hypervisor time slot scheduling intervals;

FIG. 5 is a functional block diagram showing prioritized process-context and interrupt handler run queues assigned to four hypervisor time slot scheduling intervals.

### DETAILED DESCRIPTION OF THE PREFERRED EMBODIMENT

The invention will now be described by way of exemplary embodiments shown by the drawing figures, in which like reference numerals indicate like elements in all of the several views.

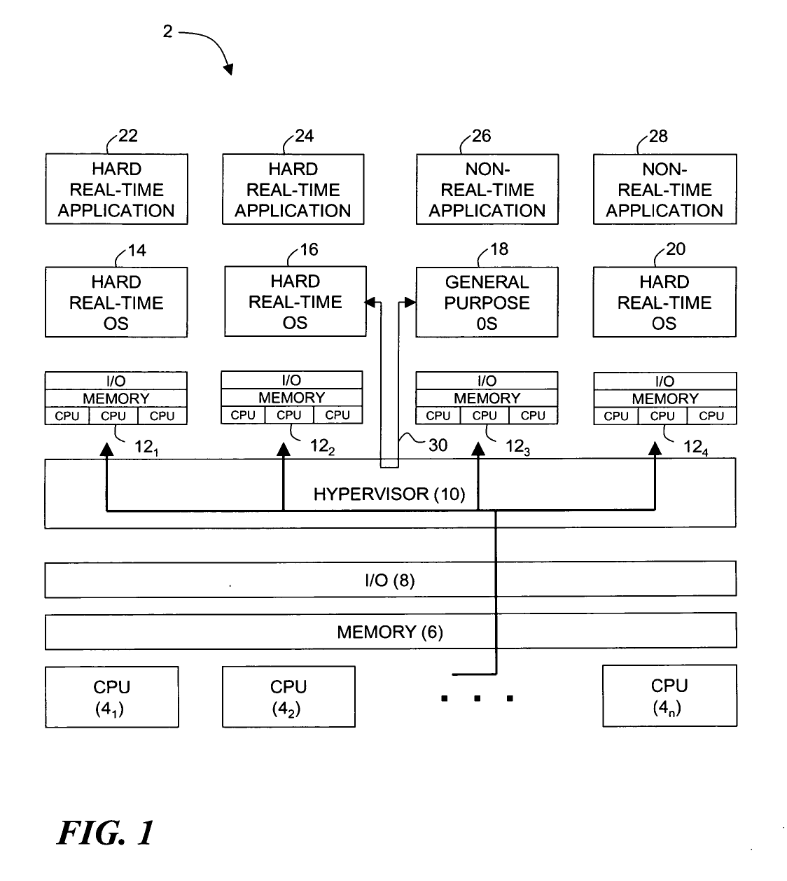

Turning to FIG. 1, a data processing system 2 is implemented with a collection of shared data processing hardware resources that include one or more central processing units (CPUs) 4₁, 4₂ . . . 4ₙ, a shared memory 6, and a set of input/output (I/O) facilities 8. A hypervisor program 10, also known as a virtual machine monitor or VMM, executes on the system 2 to provide a virtual machine (VM) environment for various operating system instances and application programs to be described in more detail below. Except for modifications that may be required to facilitate real-time scheduling support for hard RTOSes, the hypervisor 10 is conventional in nature and can be implemented according to any of the VMM design concepts that have been in use since hypervisors were first developed in the late 1960s (taking into account the VM support capabilities of the underlying hardware). Well known examples of commercial hypervisors include the CP Control Program used in the IBM VM/370® mainframe product introduced by International Business Machines Corporation in 1972, the current zVM™ hypervisor used in the IBM zSeries® mainframe product, and the hypervisor used in the IBM pSeries® and iSeries™ PowerPC products. Note that the reference to the foregoing commercial products is not in any way intended to suggest that the invention is limited to mainframe or midrange computing environments with extensive hardware resources. Quite the contrary, it is preferable that the invention be capable of implementation on any hardware platform having the ability to support virtual machine environments and concurrent RTOS and GPOS operations through the addition of appropriate hypervisor functionality. This includes platforms based on the Intel x86 architecture, which although not ideally suited for supporting virtualization, can be so adapted with the use of commercially available software such as the VMWare® product from VMware, Inc. Embedded systems are of particular interest relative to the invention. In such systems, the available hardware resources could be quite modest (e.g., a single processor adapted for embedded system use, 4-8 MB of RAM per OS, a PCI (or ISA) I/O bus, and possibly a RAM disk, a ROM disk or a flash memory to support a file system).

As is well known to those skilled in the art, a conventional hypervisor or VMM is a low level software service that virtualizes the underlying hardware to provide a subset of the CPU, memory and I/O resources (i.e., a virtual machine) on behalf of higher level “guests.” In FIG. 1, the hypervisor 10 is assumed to provide four VM environments 12₁, 12₂, 12₃ and 12₄ on behalf of four operating system instances 14, 16, 18 and 20. The operating systems 14, 16 and 20 are assumed to be hard RTOSs, while the operating system 18 is assumed to be a GPOS (or a soft real-time OS). Each of the operating systems 14, 16, 18 and 20 respectively run at least one application 22, 24, 26 and 28. In FIG. 1, the applications 22, 24 and 28 are assumed to be hard real-time applications, and the application instance 26 is a non-real-time application.

The hypervisor 10 performs various functions that support concurrent operation of the OSes 14-20 and their applications 22-28 on the system 2. In particular, the hypervisor 10 provides the plural virtual machine environments 121, 122, 123 and 124 by allocating CPU bandwidth, memory and I/O facilities for use within each virtual machine. Each OS 14-20 and its application 22-28 running within a virtual machine 12-124 behaves as if it were operating on real hardware, with the hypervisor facilitating such operation by (1) translating accesses to virtual memory and I/O space to real memory and I/O space accesses, (2) selectively distributing interrupts from I/O devices to the various OSes for servicing, and (3) scheduling CPU process execution on a prioritized basis.

Lastly, and of significance to the present invention, the hypervisor 10 supports optimized inter-OS communication, thereby allowing any OS or application to request services from any other OS or application running on the system 2. Such inter-OS communication usually does not need to implement protocols for reliable delivery, sequencing, fragmentation or de-fragmentation of data, and therefore yields less overhead and latency. Hypervisor mechanisms that may be used for such communication include those found in the IBM zVM product line, such as IUCV (Inter-User Communication Vehicle) and VCTC (Virtual Channel-To-Channel Connections). As is well known, IUCV provides a high-speed pipe for communications between virtual machines using IUCV connections that can be established between pairs of virtual machines on the same hardware platform or on different platforms. VCTC provides cross-memory communication using virtual CTC devices that are established on each virtual machine. I/O operations to these devices are intercepted by the hypervisor, which moves the data between the virtual machines involved in the transaction. Inter-OS Communication can also be supported by sharing memory between OSes.

It will be appreciated in light of the foregoing that the system 2 provides an environment in which the GPOS 18, or its non-real-time application 26, can service requests from any of the RTOSes 14, 16 and 20, or their hard real-time applications 22, 24 and 28, via the communication mechanisms provided by the hypervisor 10. Reference numeral 30 represents an example of such communication in which the RTOS 16 exchanges information with the GPOS 18 (and/or associated libraries). Through this mechanism, operations of the RTOS 16 can be augmented with such GPOS services as networking, file access, web-related tasks, security-related tasks, etc.

By way of example, the RTOS 16 might run a real-time application 24 that processes high speed streaming video traffic received on a serial link. Each processed video frame could be stored in a memory region shared with the GPOS 18. As this occurs, the RTOS 16 could provide a memory pointer to the GPOS 18 via the communication channel 30, and the GPOS would use the pointer to retrieve the video frame. The GPOS 18 could then process the video frame in a variety of ways, such as by appending the video frame to a file, sending it out over a local area network, or displaying it on a video output device.

In order to implement the foregoing functionality, the only modification required in the various operating systems is the ability to request and receive communication services from the hypervisor 10. On the hypervisor side, interrupts may in some cases need to be multicast to multiple OS instances due to the structure of some industry-standard I/O busses, in which case the OSes may also need to be modified to ignore unwanted interrupts.

The only other desirable modification of the hypervisor 10 is that it be capable of performing real-time scheduling, such that the RTOSes run efficiently side by side, or by turns, depending on the demands of each OS, the capabilities of the hardware platform, and the nature of the real-time deadlines. Although hypervisors have been used for quite some time, as far as known they have not been used to host hard real-time operating systems. One way to do this is to implement a hypervisor using an RTOS that has been enhanced to handle all of the needed I/O device requirements and to provide the necessary level of virtualization to support concurrent virtual machines. Another option (for use with Intel x86 architecture systems) would be to base the hypervisor on software such as the VMWare® product from VMware, Inc. According to the design of that product, a VMM with both direct execution and binary translation capability cooperatively shares system-level control of the underlying hardware with a host OS. With proper modifications to support real time requirements, this VMM could potentially support one or more RTOSes in virtual machines while cooperating with a host GPOS that provides the GPOS service functions needed by the RTOSes.

Another aspect of hypervisor design that is pertinent to the present invention stems from the desirability of storing the hypervisor code in read-only storage as opposed to read-write storage. The read-only storage might be a ROM, a CD, a DVD, or other read-only device. Storing the hypervisor on such a device would prevent the possibility of unrecoverable failures (with associated service costs) that could result if the hypervisor is stored in a read-write storage facility that becomes corrupted. Placing the hypervisor code in read-only storage will guarantee that the system becomes functional to the point where it can interact with the user to assist troubleshooting. This would entail running an operating system and applications, both of which require hypervisor support. Another motivation for storing the hypervisor code in read-only storage is to facilitate enhanced operational security using measures such as “trusted booting.” Loading the hypervisor from read-only storage device would enhance its trustworthiness relative to the operating system and application layers that load above the hypervisor.

An issue that arises from placing a hypervisor in read-only storage is how to periodically update the hypervisor's scheduling algorithms to accommodate current needs. Updating the hypervisor code in read-only storage will in many cases be infeasible depending on the frequency of the updates and the associated costs of implementation. For consumer-oriented embedded system devices, supporting read-only storage updates will typically be infeasible due to high unit volumes, low prices, and a lack of service agreements with customers.

The present invention addresses this situation by providing alternatives for adaptively updating hypervisor scheduling algorithms without having to update any hypervisor code stored in read-only memory. This can be accomplished in several ways. One approach is to provide a small number of relatively simple scheduling mechanisms in the hypervisor, such as a simple strict-priority scheme and a time-slotted mechanism with possible gang-scheduling capability (see below). One of these scheduling mechanisms would be selected as the default at power-on time. A different scheduling mechanism can then be selected by rebooting.

A more sophisticated approach can be used for OSes and applications that need a larger number of scheduling choices or require that the scheduling algorithm change in reaction to changes in workload or the types of OSes or applications which are present. According to this approach, the hypervisor's scheduling algorithms are encapsulated into a programmable policy manager that is implemented outside of the hypervisor (e.g., as part of or on top of an operating system), preferably loaded from read-write storage so that the policy manager can be modified or new policy managers installed as required. This approach allows the hypervisor to remain in read-only storage, safe from data corruption, but allows the system to adapt to changing conditions using policy manager control of the hypervisor.

A suitable mechanism, such as verification checks using public key certificates, may be used to ensure that the policy manager is legitimate. Once authenticated, the policy manager may implement scheduling changes in several ways. One approach is for the policy manager to select one of several scheduling mechanisms that are coded within the hypervisor (as discussed above). Another approach is for the policy manager to supply non-default parameters to one of the scheduling mechanisms coded within the hypervisor. A further approach is to code the hypervisor to register callbacks to the policy manager. These callbacks are then invoked by the hypervisor when it needs to make a scheduling decision, such as when a process is started, terminated, or issues a system call to change its schedule. The policy manager evaluates the situation and passes a decision back to the hypervisor. Although the callbacks will impose some additional overhead on the hypervisor, this overhead should be acceptable in most cases given that scheduling changes should be relatively infrequent. Situations that cannot tolerate the overhead may use one of the other approaches described above.

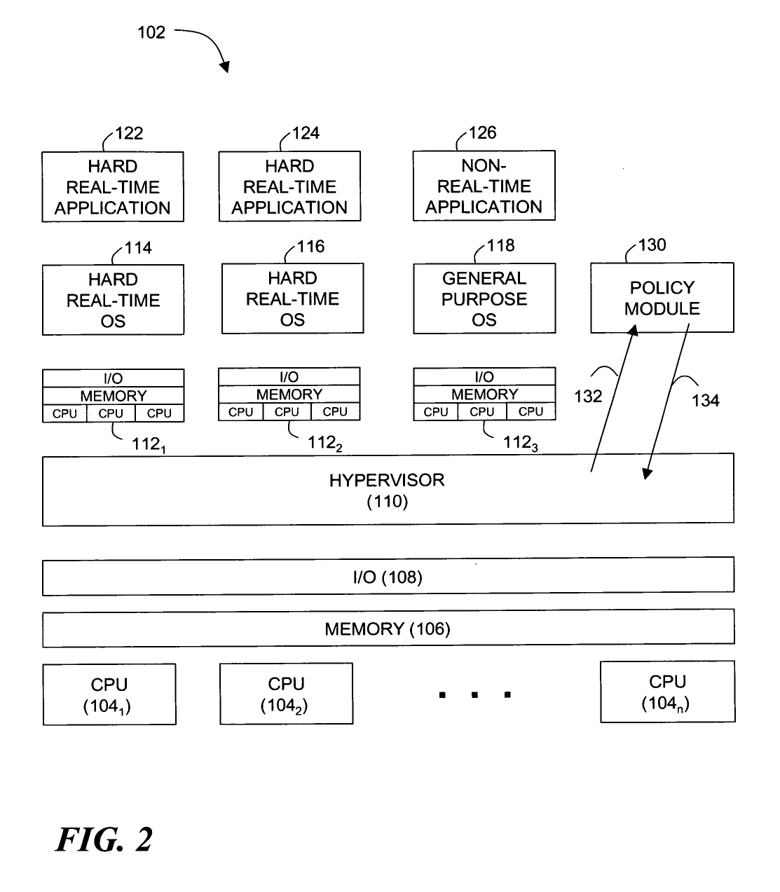

FIG. 2 illustrates how the callback approach can be implemented in a system 102 that is identical in all respects to the system 2 of FIG. 1 (as shown by the use of corresponding reference numerals incremented by 100), except that a policy manager 130 is present. The arrow identified by reference numeral 132 represents a callback-triggered scheduling policy query made by the hypervisor 110 to the policy manager 130. The arrow identified by reference numeral 134 represents the policy manager's reply.

It will be appreciated that the policy manager 130 can be incorporated into the system 102 in several ways, including as a standalone application running on top of the hypervisor 110, as shown in FIG. 2. Other options include incorporating the policy manager 130 as a driver or module within one of the operating systems 114, 116 or 118, or as an application running on one of the OSes.

There are some advantages to incorporating the policy manager 130 into the GPOS 118 (either as driver, kernel module, or application). For example, the policy manager 130 could take advantage of rich services provided by the GPOS 118, including file systems, networking, systems management, process management, and RAS (Remote Access Server) features. Another advantage is that policy manager debugging would be simplified by the availability of debugging tools from the OS. A further advantage is that developing and maintaining the policy manager 130 would be more practical due to the large number of developers familiar with existing GPOS APIs. One potential disadvantage of incorporating the policy manager 130 into any of the OSes 114, 116 and 118 is that the quality of service provided by the policy manager would be limited to that which the OS can support.

Scheduling Example

The following example illustrates how the policy manager 130 can adaptively manage the hypervisor 110 to implement scheduling policies according to the operational requirements of the OSes and applications running on the system 102. This example assumes that one of the real-time applications 122 or 124 in FIG. 2 faces hard real-time deadlines in connection with streaming video processing. However, the concepts discussed herein are not limited to video applications, and would apply equally to other situations where hard real-time deadlines exist, such as motion-control of heavy machinery, stabilizing inherently unstable aircraft, or controlling potentially hazardous chemical reactions.

The real-time scheduling performed by the hypervisor 110 attempts to allocate CPU resources according to sequential time slots whose duration is fixed and guaranteed. Each scheduling slot represents a hypervisor scheduling interval in which some combination of tasks (processes, interrupt handlers, etc.) are given CPU access according to their relative priorities. In the present example involving video processing, the hypervisor 110 can be programmed by the policy manager 130 to implement some fixed number of hypervisor scheduling slots during each successive video frame interval. One or more of these scheduling slots will be assigned to the real-time video processing application. Because the sequence of scheduling slots repeats every video frame interval, it will be guaranteed that the real-time application is given enough CPU time to process each video frame.

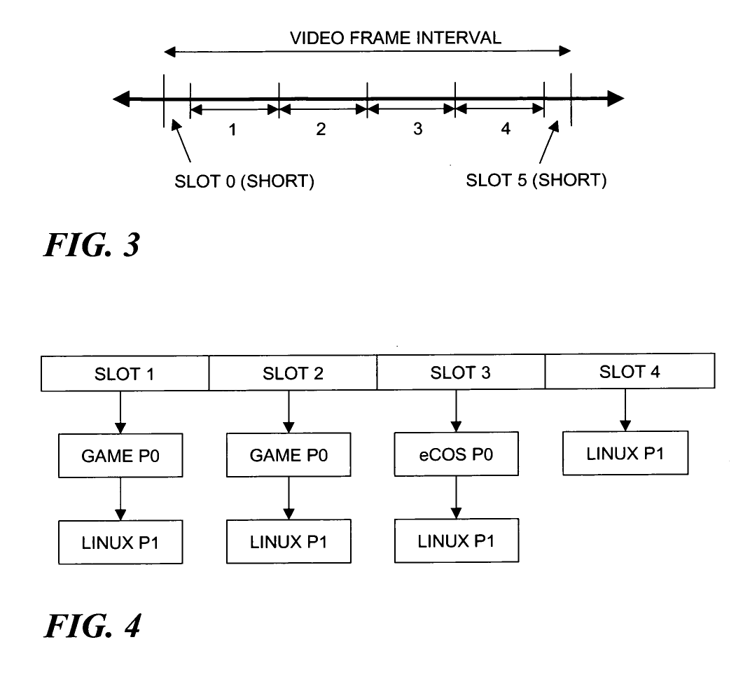

In some cases, it may be possible to synchronize the scheduling slot timing with the video frame interval so that the latter is divided into some integer number of scheduling slots, all having the same slot-interval duration. In other cases, hardware limitations may prevent such synchronization. In that case, as shown in FIG. 3, the partial zeroth and nth slots within the video frame interval may vary in duration, and may disappear entirely in some video frame intervals. This will not affect real-time applications so long as such slots are not used for real-time processing. Thus, in FIG. 3, real-time processes should use only fixed-sized slots 1 through 4, never the variable-sized slots 0 and 5. However, the latter can be assigned to non-real-time processes (which do not require fixed duration scheduling slots) to maximize CPU utilization.

The number of slots per video frame interval can vary from one to some fixed bound set by hardware limitations and performance considerations. This number can be changed at runtime, but such a change would not normally be recommended while the RTOS supporting the video application is running, unless that OS is aware of and cooperating with the change. Note that the policy manager 130 is not involved in hypervisor scheduling except during a change in slot allocation or slot-interval duration. In a typical video application, such changes would be infrequent. For example, a hypervisor scheduling change would be required when the video application is launched, and thereafter when it terminates. In addition, a scheduling change could be requested by the video application if it alters its mode of operation while executing. This might happen if the video application consisted of multiple segments that had different real-time requirements, such as one segment that implements a dumb playback mode and another segment that implements an interactive mode. The scheduling request could be made by way of a system call to the application's RTOS, which, in turn, would notify the hypervisor 110.

In some cases, the policy manager 130 might be required to do nothing more than select a scheduling policy at system power-on or reboot time, particularly if the video application is launched automatically upon system start-up. As discussed above, the scheduling policy could be implemented by selecting one of several scheduling mechanisms that are coded within the hypervisor 110, or supplying parameters that dictate how such mechanisms are to be implemented.

More typically, however, the above-described callback mechanism will be used to implement scheduling policies. The hypervisor 110 will issue a callback request to the policy manger 130 when it needs to make a scheduling change. In response to the callback request, the policy manager 130 will provide updated scheduling information. In particular, as will now be described, the policy manager 130 can supply a scheduling policy to the hypervisor 110 by way of a “scheduling list” that specifies timeslot and priority information for the various running processes.

Process-Context Code

For process-context code (as opposed to interrupt handlers, which are discussed below), the policy manager 130 supplies the hypervisor 110 with a scheduling list, each element of which contains a process identifier and a bitmask indicating slots and a priority. The hypervisor 110 uses the information in the list when making scheduling decisions. A given CPU's run queue might appear in the different slots as shown in FIG. 4.

In FIG. 4, a real-time game that runs directly on the hypervisor 110 (and is responsible for processing video frames according to the present example) is given slots 1 and 2 with a priority of 0. A GPOS, such as Linux, is also assigned to slots 1 and 2 with a priority of 1. Because its priority is lower than that of the game (1 versus 0), Linux is only allowed to use CPU cycles that the game does not consume. Another operating system, such as the eCOS real-time operating system, is given slot 3 with a priority of 0, and again, Linux (with a priority of 1) may use any cycles that eCOS fails to consume. Slot 4 is dedicated to Linux in order to guarantee that Linux will be able to supply networking and file system services to the game and to eCOS.

The hypervisor 110 is programmed by the policy manager 130 to implement the schedule shown in FIG. 4 by way of the following scheduling policy list in which (by way of example only) four bits of each bitmask are used as slot identifiers and the remaining four bits are used as priority identifiers:

Bitmask

| Process | Slots | Priority |
|---|---|---|
| Game | 1100 | 0000 |
| eCOS | 0010 | 0000 |
| Linux | 1111 | 0001 |

As mentioned, the policy manager 130 also specifies the slot duration, which in the present example would be sufficient to provide four slots per video frame interval. Note that the hypervisor 110 will preferably convert the foregoing list into one or more data structures that are more suitable for efficient internal use (e.g., by allowing the hypervisor to quickly implement the context switches required whenever the process run queues change according to the slot assignments).
Interrupt Handlers

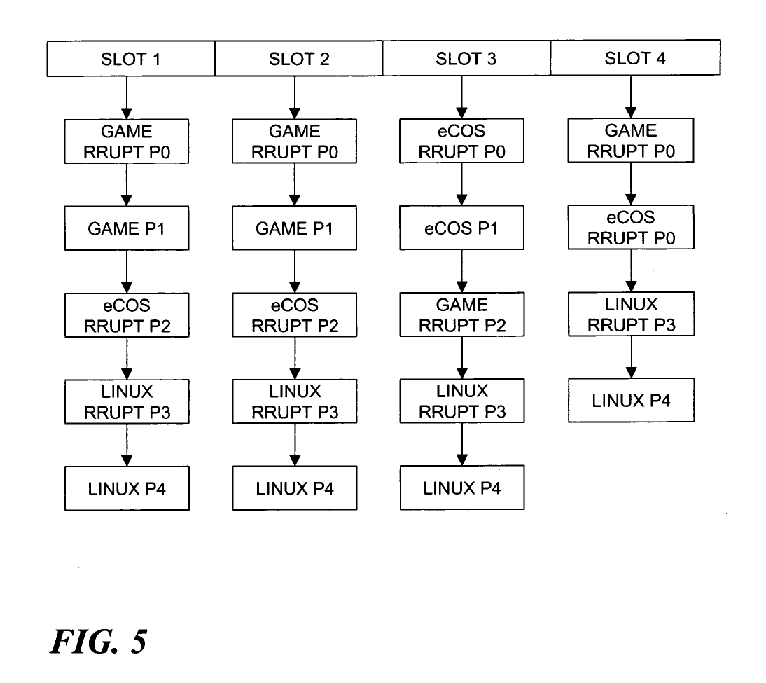

Separate priorities are required for interrupt handlers, but are specified and represented in the same manner as process-level priorities. Thus, FIG. 4 can be expanded to include interrupt handlers so as to create the situation shown in FIG. 5. In FIG. 5, any interrupt may be handled while Linux is running. However, while one of the real-time processes is running, only an interrupt for that process may be handled. Slot 4 allows real-time interrupt handlers to run at equal priority such that these handlers will run on a first-come, first-served basis, but always ahead of Linux and its interrupt handlers.

The hypervisor 110 is programmed by the policy manager 130 to implement the schedule shown in FIG. 5 by way of the following scheduling policy list:

Bitmask

| | Slots | Priority |
|---|---|---|
| Process | | |
| Game | 1100 | 0001 |
| eCOS | 0010 | 0001 |
| Linux | 1111 | 0100 |
| Interrupt | | |
| Game | 1101 | 0000 |
| Game | 0010 | 0010 |
| eCOS | 1100 | 0010 |
| eCOS | 0011 | 0000 |
| Linux | 1111 | 0011 |

As discussed above, the hypervisor 110 will preferably convert the foregoing list into one or more data structures that are more suitable for efficient internal use. The hypervisor 110 will then be able to make all scheduling decisions by quickly processing the data structure contents.
Gang Scheduling

Gang scheduling considerations may need to be taken into account by the policy manager 130. For example, such scheduling would be desirable to allow the CPUs of a multiprocessor OS to be active at the same time, possibly preventing wasted CPU cycles due to a critical lock being held by a CPU that is currently running some other OS. Gang scheduling may also be needed to allow applications distributed across multiple OSes to interact efficiently. For example, an application may be partitioned into a hard real-time component running on an RTOS and a web-enabled component running on a GPOS. In many cases, system performance will be optimized if both OSes are running simultaneously, since this minimizes the time that one component must wait for the other component to take some action. Gang scheduling is important in other applications areas as well, for example, scheduling an OS that runs CPU-bound HPC (High Performance Computing) applications on the same hardware as an OS that has either hard real-time or timesharing requirements. In all of these cases, performance is optimized when all CPUs for a given OS image or application are scheduled to run concurrently.

The policy manager 130 is perhaps the best candidate to control gang scheduling given that the slots defined by the policy manager are synchronized across all CPUs. The policy manager 130 can easily implement CPU-to-process allocations by augmenting the lists shown in the preceding sections to include a vector of CPUs. For example, the scheduling policy list might appear as follows in a four CPU system running the game, eCOS and Linux processes described above in accordance with the example:

Bitmask

| Process | Slots | Priority | CPUs |
|---|---|---|---|
| Game | 1100 | 0000 | 0101 |
| eCOS | 0010 | 0000 | 0101 |
| Linux | 1111 | 0001 | 1010 |

In general, the CPU vector for a given process should not change during different slots. Thus, even though some OSes may be able to operate efficiently despite being moved from one CPU to another during different slots, there would likely be performance penalties incurred by many OSes.

Accordingly, the use of a hypervisor to enhance the functionality of an RTOS has been disclosed along with a programmable policy manager for updating hypervisor scheduling algorithms. It will be appreciated that the foregoing concepts may be variously embodied in any of a data processing system, a machine implemented method, and a computer program product in which programming means are recorded on one or more data storage media for use in controlling a data processing system to perform the required functions.

While several embodiments of the invention have been shown and described, it should be apparent that many variations and alternative embodiments could be implemented in accordance with the teachings herein. It is understood, therefore, that the invention is not to be in any way limited except in accordance with the spirit of the appended claims and their equivalents.

1. A system for enhancing a real-time operating system (RTOS) with functionality normally associated with a general purpose operating system (GPOS), comprising:
an RTOS;
a GPOS; and
a hypervisor supporting concurrent execution of said RTOS and said GPOS on a system of shared hardware resources, said hypervisor being adapted to perform a real-time scheduling function.

2. A system in accordance with claim 1 wherein said GPOS is adapted to provide services on behalf of said RTOS or its applications, said services including one or more of file system organization, network communication, network management, database management, security and user-interface support.

3. A system in accordance with claim 1 wherein said hypervisor resides in read-only storage and is adapted to implement plural scheduling mechanisms according to operational requirements.

4. A system in accordance with claim 3 wherein said hypervisor stores plural scheduling mechanisms that are selectable.

5. A system in accordance with claim 3 further including a policy manager that is adapted to control said scheduling function performed by said hypervisor.

6. A system in accordance with claim 5 wherein said policy manager is implemented as one of an application running on said hypervisor, a driver running within one of said operating systems, or a module running within one of said operating systems.

7. A system in accordance with claim 5 wherein said policy manager is adapted to control said scheduling function by selecting one of several scheduling mechanisms stored by said hypervisor.

8. A system in accordance with claim 5 wherein said policy manager is adapted to control said scheduling function by providing parameters to a scheduling mechanism stored by said hypervisor.

9. A system in accordance with claim 5 wherein said policy manager is adapted to control said scheduling function by providing a scheduling policy to said hypervisor for use in implementing a time-slotted scheduling mechanism, said scheduling policy specifying a time slot duration and a listing of prioritized tasks to be run in each time slot.

10. A system in accordance with claim 9 wherein said scheduling policy further includes one or more processor vectors to facilitate gang scheduling.

11. A method for enhancing a real-time operating system (RTOS) with functionality normally associated with a general purpose operating system (GPOS), comprising:
concurrently executing an RTOS and a GPOS on a system of shared hardware resources with support from a hypervisor; and
said hypervisor performing a real-time scheduling function.

12. A method in accordance with claim 11 wherein said GPOS provides services on behalf of said RTOS or its applications, said services including one or more of file system organization, network communication, network management, database management, security and user-interface support.

13. A method in accordance with claim 11 wherein said hypervisor is booted from read-only storage and is adapted to implement plural scheduling mechanisms according to operational requirements.

14. A method in accordance with claim 13 wherein said hypervisor stores plural scheduling mechanisms that are selectable.

15. A method in accordance with claim 13 further including controlling said scheduling function performed by said hypervisor using a policy manager.

16. A method in accordance with claim 15 wherein said policy manager is implemented as one of an application running on said hypervisor, a driver running within one of said operating systems, or a module running within one of said operating systems.

17. A method in accordance with claim 15 wherein said policy manager controls said scheduling function by selecting one of several scheduling mechanisms stored by said hypervisor.

18. A method in accordance with claim 15 wherein said policy manager controls said scheduling function by providing parameters to a scheduling mechanism stored by said hypervisor.

19. A method in accordance with claim 15 wherein said policy manager controls said scheduling function by providing a scheduling policy to said hypervisor for use in implementing a time-slotted scheduling mechanism, said scheduling policy specifying a time slot duration and a listing of prioritized tasks to be run in each time slot.

20. A method system in accordance with claim 19 wherein said scheduling policy further includes one or more processor vectors to facilitate gang scheduling.

21. A computer program product for enhancing a real-time operating system (RTOS) with functionality normally associated with a general purpose operating system (GPOS), comprising:
one or more data storage media;
programming means recorded on said data storage media for programming a system of shared hardware resources to operate as by:
concurrently executing an RTOS and a GPOS on said system with support from a hypervisor; and
said hypervisor performing a real-time scheduling function.

22. A computer program product in accordance with claim 21 wherein said programming means are further adapted to program said system to operate as by said GPOS providing services on behalf of said RTOS or its applications, said services including one or more of file system organization, network communication, network management, database management, security and user-interface support.

23. A computer program product in accordance with claim 21 wherein said programming means are further adapted to program said system to operate as by booting said hypervisor from read-only storage and enabling said hypervisor to implement plural scheduling mechanisms according to operational requirements.

24. A computer program product in accordance with claim 23 wherein said programming means are further adapted to program said system to operate as by said hypervisor storing plural scheduling functions that are selectable.

25. A computer program product in accordance with claim 23 wherein said programming means are further adapted to program said system to operate as by controlling said scheduling function performed by said hypervisor using a policy manager.

26. A computer program product in accordance with claim 25 wherein said programming means are further adapted to program said system to operate as by implementing said policy manager as one of an application running on said hypervisor, a driver running within one of said operating systems, or a module running within one of said operating systems.

27. A computer program product in accordance with claim 25 wherein said programming means are further adapted to program said system to operate as by said policy manager controlling said scheduling function by selecting one of several scheduling mechanisms stored by said hypervisor.

28. A computer program product in accordance with claim 25 wherein said programming means are further adapted to program said system to operate as by said policy manager controlling said scheduling function by providing parameters to a scheduling mechanism stored by said hypervisor.

29. A computer program product in accordance with claim 25 wherein said programming means are further adapted to program said system to operate as by said policy manager controlling said scheduling function by providing a scheduling policy to said hypervisor for use in implementing a time-slotted scheduling mechanism, said scheduling policy specifying a time slot duration interval and a listing of prioritized tasks to be run in each time slot.

30. A computer program product in accordance with claim 29 wherein said programming means are further adapted to program said system to operate as by said scheduling policy further including one or more processor vectors to facilitate gang scheduling.

31. A policy manager computer program product for use with a hypervisor running on a system of shared hardware resources to enhance a real-time operating system (RTOS) with functionality normally associated with a general purpose operating system (GPOS), comprising:
one or more data storage media;
programming means recorded on said data storage media for managing said hypervisor as by:
providing scheduling control information to assist said hypervisor implement a real-time scheduling function.

32. A policy manager computer program product in accordance with claim 31 wherein said programming means are adapted to manage said hypervisor as by providing a selection input for selecting one of several scheduling mechanisms stored by said hypervisor.

33. A policy manager computer program product in accordance with claim 31 wherein said programming means are adapted to manage said hypervisor as by providing parameters to a scheduling mechanism stored by said hypervisor.

34. A policy manager computer program product in accordance with claim 31 wherein said programming means are adapted to manage said hypervisor as by providing a scheduling policy for use in implementing a time-slotted scheduling mechanism, said scheduling policy specifying a time slot duration interval and a listing of prioritized tasks to be run in each time slot.

35. A policy manager computer program product in accordance with claim 34 wherein said programming means are adapted to manage said hypervisor program as by said scheduling policy further including one or more processor vectors to facilitate gang scheduling.

36. A system for enhancing a real-time operating system (RTOS) with functionality normally associated with a general purpose operating system (GPOS), comprising:
an RTOS;
a GPOS; and
a hypervisor supporting concurrent execution of said RTOS and said GPOS on a system of shared hardware resources, said hypervisor being adapted to:
provide a virtual machine environment for at least said RTOS;
perform a real-time scheduling function; and
facilitate inter-OS communication that allows said RTOS or its applications to utilize services provided by said GPOS.

37. A system for enhancing a real-time operating system (RTOS) with functionality normally associated with a general purpose operating system (GPOS), comprising:
an RTOS;
a GPOS; and
a hypervisor supporting concurrent execution of said RTOS and said GPOS on a system of shared hardware resources, said hypervisor being adapted to perform a real-time scheduling function; and
a policy manager that is adapted to control said scheduling function performed by said hypervisor.
